(19) United States
(12) Patent Application Publication
(10) Pub. No.: US 2004/0156321 A1
(43) Pub. Date: Aug. 12, 2004

(54) Method of determining a mesh in a computer network

(76) Inventors: Anthony Paul Michael Walker, Fort Collins, CO (US); Srikanth Natarajan, Fort Collins, CO (US); Dipankar Gupta, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/355,062

(22) Filed: Jan. 31, 2003

(51) Int. Cl. H04L 12/28

(52) U.S. Cl. 370/254

(57) ABSTRACT

A method of determining a mesh in a computer network is disclosed. In one example, a list of nodes connected to a node is maintained. The list of nodes is used to determine the meshes within a computer network. In another embodiment, interface information is obtained from the computer network concerning the connection between the interfaces in the computer network. From this interface information, node information concerning the interconnection of nodes within the computer network can be produced. This node information can be used to determine a mesh or meshes within the computer network.

### RELATED APPLICATIONS

The present application is related to the U.S. applications “METHOD OF DETERMINING A MAXIMAL MESH”, Natarajan et al., Ser. No.______, (Attorney Docket No. 100202314); “METHOD OF INDICATING A PATH IN A COMPUTER NETWORK”, Walker et al., Ser. No.______, (Attorney Docket No. 100202822-1); and “METHOD OF STORING DATA CONCERNING A COMPUTER NETWORK”, Ho et al., Ser. No.______ (Attorney Docket No, 100204008). Each of these applications is filed on the same day as the present application and is incorporated herein by reference.

### BACKGROUND

Computer networks can include meshes of nodes that provide redundancy for the computer network. A mesh is a group of at least three nodes that are fully interconnected. A failure at one of the mesh nodes can be avoided by rearranging data transfer through the network using the redundancy provided by the mesh. For example, in an Ethernet switching environment, a spanning tree defined within the computer network can be used to rearrange a path through the network in an effort to avoid a failure at a given node.

### SUMMARY

In accordance with exemplary embodiments, a method of determining a mesh in a computer network is disclosed. Topology information is obtained that indicates which nodes in the computer network are interconnected. A list of identifiers of nodes connected to a first node is produced. The topology information is examined to determine a mesh in the computer network. The examining of the topology information includes using the list to determine a candidate node for inclusion in the mesh.

In accordance with an alternate embodiment, a method of determining a mesh in a computer network includes obtaining interface information that indicates which interfaces in the computer network are interconnected. The interface information is used to determine node information indicating which nodes of the computer network are interconnected. The node information is examined to determine a mesh in the computer network.

A computer readable medium containing a program which, according to exemplary embodiments, executes the following procedure to determine a mesh in a computer network: obtaining topology information that indicates which nodes in the computer network are interconnected including producing, for a first node in the computer network, a list of identifiers of nodes connected to the first node; and examining the topology information to determine the mesh in the computer network, the examining of the topology information including using the list to determine candidate nodes for inclusion in the mesh.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 is a flow chart illustrating a method according to an exemplary embodiment.

FIG. 2 is a flow chart illustrating a method according to an alternate exemplary embodiment.

FIG. 3 is a diagram that illustrates a computer network including a mesh.

FIG. 4 is a diagram that illustrates an exemplary embodiment of a system using a mesh-determining system.

### DETAILED DESCRIPTION OF THE PREFERED EMBODIMENTS

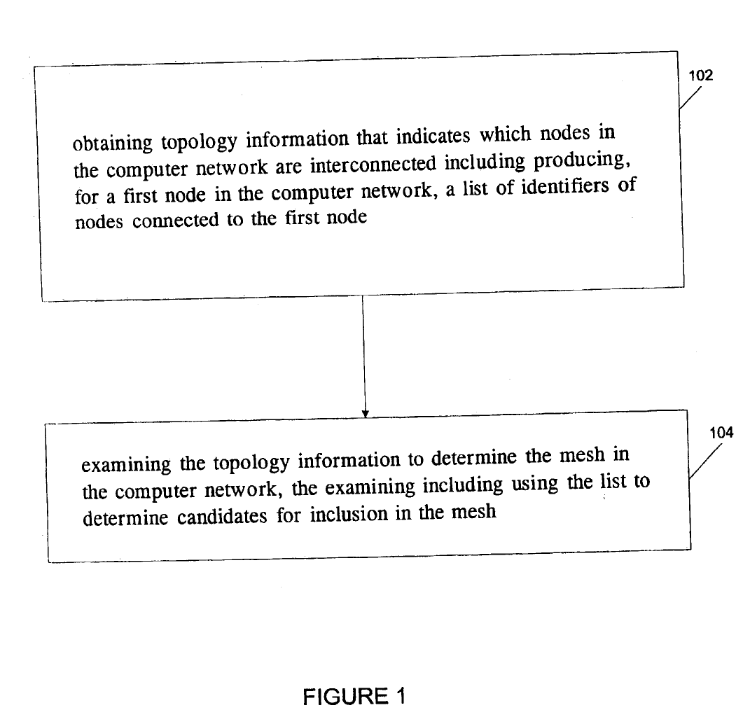

FIG. 1 is a flow chart illustrating a method of determining a mesh in a computer network. In step 102, topology information is obtained that indicates which nodes in the computer network are interconnected. The obtaining step includes producing, for a first node in the computer network, a list of identifiers of nodes connected to the first node.

A “computer network,” as used herein, is a part or all of a network which interconnects nodes, some or all of which can be computers and/or other devices. Examples of computer networks include parts or all of Local Area Networks (LANs), Wide Area Networks (WANs), or the Internet. As used herein, the term “nodes” refers to an element within or connected to the computer network. The nodes can include, but are not limited to, end nodes; routing nodes; such as routers using IP addresses; and switching non-routing nodes, such as switches which use link level addresses. In an exemplary embodiment, the computer network can include switching non-routing nodes.

Lists can be used to identify connected nodes. Identifiers can be included in a list to identify the nodes. The lists can be stored, and can be used in place of, or in addition, to connection matrices.

The use of a list of identifiers, rather than a matrix, can have advantages when, for example, multiple computer networks are involved. For example, in a computer network containing many nodes (e.g., 20,000 or more nodes), each of the nodes can be interconnected with many other nodes (e.g., ten or more nodes). Rather than keeping a full, sparsely filled connection matrix, each node can have associated with it a list of connected nodes. Such a list can involve less memory, and allow for an easier determination of the meshes.

In step 104, the topology information is examined to determine a mesh in the computer network. The examining can include using the list to determine candidates for inclusion in the mesh. As used herein, a “mesh” is a group of three or more fully-connected nodes. The nodes are fully connected because each of the nodes interconnects with each of the other nodes within the group. The term “mesh” is not to be limited to cases in which every node in the computer network interconnects with each other. Using a list to determine candidates for inclusion in the mesh can reduce the complexity of the examination of the topology information to determine the mesh.

In an exemplary embodiment, the mesh is a maximal mesh. A mesh can be considered to be maximal when it includes a largest possible number of fully interconnected nodes (that is, there are no additional nodes which are fully connected to the nodes of the mesh).

In an exemplary embodiment, multiple maximal meshes are determined. Indications of multiple maximal meshes can be useful in providing information concerning the computer network.

In an exemplary embodiment, the topology information is node information that can be determined from interface information that indicates which interfaces are interconnected. Interface information can be determined by querying the interfaces using a management protocol such as the Simple Network Management Protocol (SNMP).

Candidate nodes can be examined to determine whether they interconnect with each node in a fully connected group of nodes. This allows for the determination of the meshes.

The topology information can be examined using a computer program. The computer program can use recursion to check for the mesh. In one embodiment, the computer program keeps track of multiple fully connected groups of nodes to determine meshes.

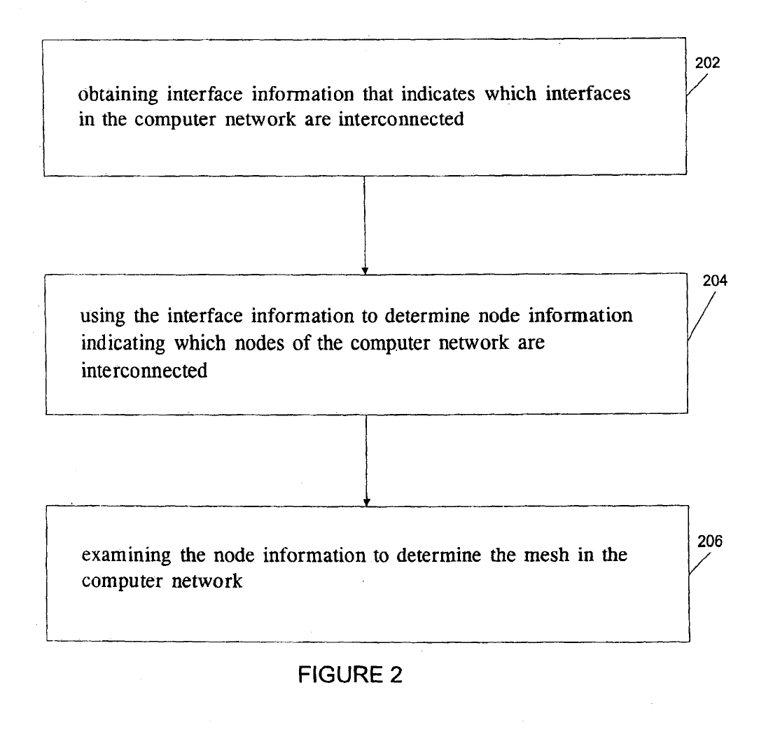

FIG. 2 is a flow chart illustrating a procedure for determining a mesh in a computer network. In step 202, interface information is obtained which indicates interfaces in the computer network that are interconnected. In one embodiment, the interface information can be obtained by using a management protocol such as SNMP.

In step 204, the interface information is used to determine node information that indicates which nodes of the computer network are interconnected. For example, each of the interfaces for a first node is also examined. Each interface that connects to one of the interfaces for the first node is determined. Multiple iterations can find all of the node interfaces. Since each interface is associated with a node, a determination of the node connections can then be made.

In step 206, the node information is examined to determine a mesh in the computer network. The node information can be used to determine the nodes that are part of meshes. The mesh can be a maximal mesh, and multiple maximal meshes can be determined.

In one embodiment, a list of identifiers of nodes connected to a first node is determined. The examining of the node information can include using the list to determine candidate nodes for inclusion in the mesh. Candidate nodes can be examined to determine whether they interconnect with each node in their fully connected group of nodes.

The method can be implemented using a computer program. The computer program can use recursion to determine the mesh or meshes. The computer program can keep track of multiple fully connected groups of nodes. Keeping track of multiple fully connected groups of nodes can aid in the determination of the mesh or meshes.

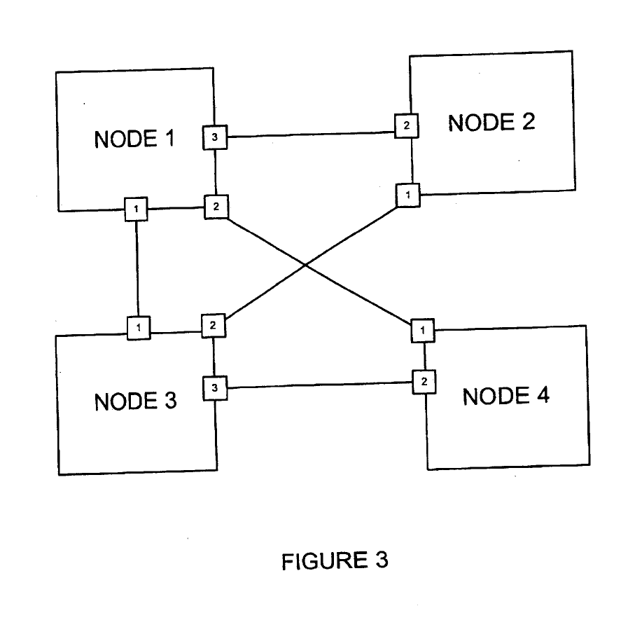

FIG. 3 illustrates an example of a computer network with four nodes, and can be used to illustrate how topology information can be examined for determining a maximal mesh. The FIG. 3 example can be defined by a global connectivity graph which illustrates the connectivity of the nodes of FIG. 3:

| | 1 | 2 | 3 | 4 |
|---|---|---|---|---|
| 1 | 0 | 1 | 1 | 1 |
| 2 | 1 | 0 | 1 | 0 |
| 3 | 1 | 1 | 0 | 1 |
| 4 | 1 | 0 | 1 | 0 |

The topmost row and the leftmost column, which are in bold, represent the nodes in the graph. The cells that are marked 0 indicate there is no connection between the nodes. For example there is no connection between nodes 2 and 4. The cells that are marked 1 indicate there is a connection between the nodes. For example there is a connection between nodes 2 and 3. Connections are non-directional. This means if there is a connection between 1 and 4, it is assumed that there is a connection between 4 and 1 also. This will be represented by marking a “1” on the intersection of both row 1 column 4, and also on row 4 and column 1 in the matrix.

As an example, let “n” be the total number of nodes in the graph. This indicates the global connectivity has the size n by n. The term clique represents a group of nodes that are fully connected to each other. In one embodiment, a clique is an array of integers. The elements of the array are values 0 or 1. The position of the element represents the number of the node. If a particular element has a value 0, it means that the node is not in the mesh. If it is 1, this indicates the node is in the mesh. Consider the following clique.

| 0 | 1 | 1 | 0 | 1 | 1 | 0 |
|---|---|---|---|---|---|---|
| 1 | 2 | 3 | 4 | 5 | 6 | 7 |

In this clique, nodes 2, 3, 5, and 6 are in the mesh.

One exemplary process to find the maximal fully connected group of nodes from the computer network of FIG. 3 starts with node 1. It is checked whether node 2 is connected to node 1. Node 1 and node 2 are connected and thus are a fully connected group. A new candidate node, in this case, node 3, is checked to see whether it forms a fully connected group with nodes 1 and 2. Node 3 does form a fully connected group with nodes 1 and 2. It is then checked to determine whether node 4 interconnects with each of nodes 1, 2 and 3. Node 4 does not interconnect with all of these nodes. Since there are no other additional candidate nodes, the group of nodes 1, 2 and 3 are indicated as being at a maximal mesh.

There may be another maximal mesh would also be 1, 3 and 4, which includes some of the nodes of the mesh {1, 2, 3}. Since each of the nodes in the mesh {1, 2, 3} are fully interconnected, each subgroup of nodes in the mesh is fully connected. Other candidate nodes outside of the mesh are tested with subgroups of the mesh to determine if they form another mesh. In this case, the subgroup of nodes 1 and 3 added to candidate node 4 forms a maximal mesh {1, 3, 4}. Thus two maximal meshes; mesh {1, 2, 3} and mesh {1, 3, 4} are determined.

A mesh can be stored as an array of node indices similar to the clique structure above. This mesh can in turn, be a part of a global array of maximal meshes.

Pseudocode labeled “Rclique” represents one way of determining maximal meshes. Rclique is a recursive function that can be called to determine maximal meshes. CurrentLevel represents the current node from which the execution of the routine Rclique begins. Current clique is the newest clique (mesh) that is being found. An example of a general process for determining maximal meshes, using a matrix of node connections, is as follows:

```
Rclique( currentLevel)
{
  If (currentLevel > n)
  {
    if (size of the current clique >= 3)
    {
      if (the current clique changed in this recursive flow)
      {
        create a new mesh object
        check if this mesh is a subset of an existing mesh
        If no then
          store it in the global array of meshes
        Else
          Free the mesh
      }
    }
    Set current clique changed variable to 0 (basically reinitialize for the
  next run)
    Return from this run
  }
  Check if the node at currentLevel is connected to everyone
  in the current
  clique
  If yes then
  {
    Add this node to the current clique
    Increase size OfCurrentClique by 1
    Mark the current clique as having changed
    Call Rclique (currentLevel + 1)
    Reduce size of current clique by 1 since we have taken care of the
  currentLevel
  }
  Remove the currentLevel node from the currentClique by
  setting the array
  element for the node to 0
  Call Rclique(currentLevel + 1)
}
```

In the above example, Rclique is a recursive function. If all possible candidate nodes have been checked (currentLevel>n), then the size of the current clique is tested. If the size of the current clique is greater than 3, it is tested to see whether the clique had changed in this recursive flow. If so, a new mesh object is created. Next, it is checked if the mesh is a subset of an existing mesh. If not, the new mesh is stored in an array of meshes. Otherwise the new mesh is not stored (i.e., it is “freed”) in the array of meshes.

In an exemplary embodiment, maximal meshes are stored. If the new mesh is a subset of an existing mesh, the clique change variable is set to 0 to reinitialize for the next run and Rclique returns. It is checked whether the node of the current level is connected to everyone in the current clique. If so, the node is added to the clique and Rclique is recursively called. After the return from the recursive call of Rclique, the size of the current clique is reduced by one. If the node isn't connected to all other nodes in the current clique, the current level node is removed from the current clique by setting the array element to node 0. After the removal of the node from the current clique, Rclique is recursively called.

The recursive process steps through each of the possible meshes. However, those skilled in the art will appreciate that the computer program need not be a recursive function. Rather, recursive functions are an exemplary way to check possible mesh combinations.

Networks such as computer networks, can contain a large number of network nodes. For example, where 20,000 or more network nodes are involved, the connection matrix would likely be large, but sparse, since the number of connections for any one node would be much less than 20,000.

In an alternate embodiment, rather than using a connection matrix, indications of nodes that are connected to specific nodes can be stored as a list (e.g., a list of identifiers for each node which indicates those nodes which are connected to each node). In this way, the memory requirements for the topology information can be reduced.

In one example, the computer network topology discovery can also identify (e.g., find) network interfaces rather than network nodes. The computer network discovery operation can determine the connectivity of these interfaces. Network nodes can be considered to act as containers which collect sets of related interfaces. These interfaces can be managed as a group and defined by a single SNMP agent.

In one embodiment, the connectivity of interfaces is determined, and this interface information can be used to determine node connectivity information. In the example of FIG. 3, the interconnection between the interfaces is collected. Interface 1 of node 1, connects with interface 1 of node 3, and so on. This interface information can be collected to ensure that both interface 1 at node 1 indicates that it connects to interface 1 of node 3, and that interface 1 of node 3 indicates that it connects to interface 1 of node 1. This double-checking can avoid errors in a Management Information Base (MIB) stored, for example, at one of the interfaces.

The topology information can be received in any order. In FIG. 3, if a report from interface 1 of node 1 is received saying that it connects to interface 1 of node 3, a record is produced saying that there is a potential connection between the two interfaces. Once a report is received from the interface 1 of node 3 confirming this connection, the interface connection is then indicated as being correct.

In an exemplary embodiment, the interface connections are stored as a list for each interface (e.g., for each interface, a list of identifiers can indicate those interfaces to which each interface connects). An array of interface connection information lists can be created will allow the construction of node connection information.

Once the interface connections are determined, the node connections can be found. In FIG. 3, node 1 has interfaces 1, 2, and 3. A determination is made of those interfaces to which node 1 connects. In this case, the connected interfaces include interface 1 of node 3, interface 1 of node 4, and interface 2 of node 2.. Thus, it is found that node 1 connects to nodes 2, 3 and 4. Indications of nodes 2, 3 and 4 are then added to a node connection list. The list can also include indications of nodes that are not confirmed to be connected, but there is some evidence of a connection (e.g., where a first interface indicates it is connected to another interface, but the other interface does not confirm that it is connected to the first interface; that is, partial evidence of a connection).

A computer program to find the maximal meshes can use the lists of the connected nodes. Looking again at FIG. 3, such a computer program can- start at node 1 and go to the first indication in the list of connected nodes of node 1. In this case, the first indication in the list is node 2. Since node 1 and node 2 interconnect, they form a fully connected group. The second connected node for node I is then checked. In this case, the second connected node for node 1 is node 3. Node 3 interconnects with nodes 1 and 2, so node 3 is added to the fully connected group. The third node connected to node 1 is node 4 which is checked to see whether it connects with each of nodes 1, 2, and 3. Since node 4 does not connect to node 2, it is not added to the clique. Since there are no more nodes in the list of connected nodes, it is determined that nodes 1, 2 and 3 are a maximal mesh.

Nodes can be removed from the clique and additional node interconnections determined. When node 2 is removed from the clique and node 4 is checked, it is determined that nodes 1, 3 and 4 form a mesh which, in this case, is a maximal mesh. The use of a list of connected nodes can reduce the number of candidate nodes to be examined and speed up the mesh discovery especially when, for example, the computer network has sparse connections.

As an alternate to the Rclique procedure already discussed, another example of pseudocode for mesh determination that uses lists of connections rather than a matrix is as follows:

Find All Switch Meshes

For all nodes,

Get next current node

Ensure that current node is valid and is a switch rather than a router

Get list of nodes connected to current node

Check each node in list for validity and to ensure that it is a switch

If current node connected to two or more qualified nodes

Run Recursive Clique Check (current node, current group, list of qualified connections, group changed indicator)

The Find All Switch meshes procedure checks each node to insure that the current node is valid and a switch rather than a router. In one embodiment, switches are examined for membership in a mesh. The list of nodes connected to the current node is obtained. Each node in the list is checked for validity to ensure it is- a switch. If the current node is connected to two or more qualified nodes, the Recursive Clique Check procedure is run. An example of a procedure for the Recursive Clique Check, which can be used to identify the nodes of maximal meshes, is as follows:

```
Recursive Clique Check
  (Test node
  Current group
  List of qualified connections
  Group changed indicator)
  if test node is not connected to every node in current group return
  If no nodes are in list of qualified connections set terminate flag
  else
    remove a node from list of qualified connections
    set removed node as the new node
  create new current group consisting of test node added to current group
  set group changed indicator
  if terminate flag set
      Terminate Mesh Recursion (new current group, group
    changed indicator)
    Else
      Recursive Clique Check (new node, new current group, list of
    qualified connections, group changed indicator)
  if terminate flag set
      Terminate Mesh Recursion (current group, group changed
    indicator)
  Else
      Recursive Clique Check (new node, current group, list of
    qualified connections, group changed indicator)
```

When Recursive Clique Check is first called, the current node is set as a test node. If the test node is not connected to every node in the current group, the recursive clique check returns. If there are no nodes in the list of qualified connections, a terminate flag is set. Otherwise, a node is removed from the list of qualified connections and the removed node is set as the new node. A new current group is created with the test node being added to the old current group, and the group change indicator is set.

If the connected flag is set,- a first call is performed. -If the terminate flag is set, the procedure Terminate Mesh Recursion is called using the new current group rather than the old current group. Otherwise, the procedure Recursive Clique Check is called using the new current group rather than the old current group.

When either of these calls returns or if the connected flag is not set, a second call is made. If the terminate flag is set, the Terminate Mesh Recursion Procedure is called using the current group rather than the new current group. Otherwise, the Recursive Clique Check is called using the current group rather than the new current group.

An example of a Terminate Mesh Recursion, used to identify a maximal mesh, is as follows:

```
Terminate Mesh Recursion
  (test group,
  group changed indicator)
  If test group size is less than three
    clear group change indicator
    return
  else
    if test group is a subset of a previous mesh
      clear group changed indicator
      return
    else
      add test group to set of meshes
```

Pursuant to the Terminate Mesh Recursion procedure, if the test group size is less than 3, the test group cannot be a mesh. In this case, the group change indicator is cleared and the procedure returns. Otherwise, if the test group is a subset of a previous mesh, the group change indicator is cleared and the system returns. Meshes that are found that are subsets of other meshes are not added as the new mesh. If a previous mesh is a subset of the test group, the test group replaces the previous mesh in the set of meshes. Otherwise, the test group is added to the set of meshes.

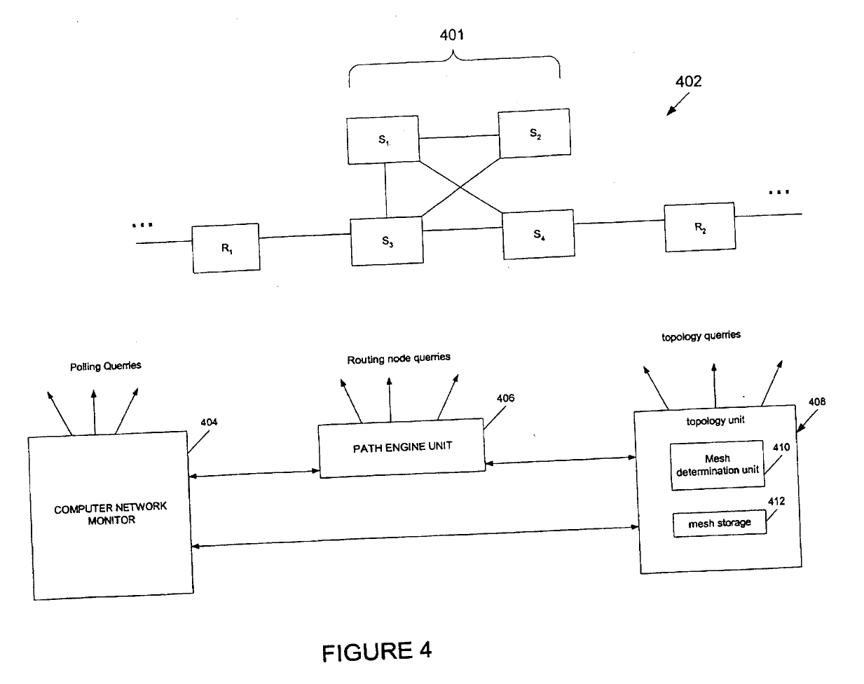

FIG. 4 is a diagram that illustrates a system adapted for mesh determination. In the FIG. 4 example, a computer network 401 includes switches S₁, S₂, S₃, and S₄ located between routers R₁ and R₂ in a larger computer network 402. A topology unit 408 produces topology queries to the interfaces of the switches S₁, S₂, S₃ and S₄. The topology unit 408 receives interface information in response to the queries. The topology unit 408 uses the interface information to create node (topology) information concerning the interconnection of the nodes S₁, S₂, S₃ and S₄. The topology information is evaluated in a mesh determination unit 410 to determine the meshes within the computer network. In this example, the meshes S₁, S₂, S₃ and S₄ are determined.

Mesh information, or data, is stored in the mesh storage 412. A path engine unit 406 can use the mesh data to produce path information between nodes. The path engine unit 406 can be used to determine a path through a larger computer network. For example, the path through nodes R₁, S₃, S₄, and R4 can be determined. Although the path engine unit 406 is described herein for purposes of understanding exemplary embodiments, additional features of an exemplary path engine unit are described in the U.S. patent application Walker, et al. “Method of Indicating a Path in a Computer Network”, Ser. No.______, (Attorney Docket No. 102202822-1).

Once a path is determined, it can be examined for stored mesh data to determine whether any of the connections in the path are part of a mesh. In this case, the connection between nodes S₃ and S₄ is part of a mesh and this mesh indication can be added as part of the path information. The mesh data allows the path information to indicate multiple paths. In the FIG. 4 example, the path information can be sent to a computer network monitor 404 which can use the path information to help determine a network failure within the larger computer network 402.

The mesh data can distinguish between internal and external interfaces to the mesh. In the FIG. 4 example, the interface on S₃ that connects to S₄ is an internal interface to the mesh. The failure of this interface can be avoided by reconfiguring the switching nodes (in a new spanning tree, for example). For example, when the computer network 404 uses a spanning tree algorithm and the failed mesh interface is in the current spanning tree, the spanning tree algorithm can modify the spanning tree to avoid the failure at the interface for internal nodes of the mesh.

The interface on S3 that connects to R₁ is an external interface of the mesh. In the FIG. 4 example, this external interface cannot be avoided by reconfiguring the switches.

In one example, the meshes can be treated as objects having the external interfaces. An example of such a mesh storage system is described in the patent application “METHOD OF STORING DATA CONCERNING A COMPUTER NETWORK”, Ho et al., Ser. No.______ (Attorney Docket No. 100204008) incorporated herein by reference.

In the example FIG. 4, meshes within a switching node portion of the larger computer network 402 are found, and meshes are defined in such a manner that they do not cross routing node borders (i.e., in an exemplary embodiment, meshes do not include routing nodes). In FIG. 4, the path engine unit 406 is used to determine a path of packets through the system. The path of packets through the system is set by the routing tables. For example, the path may pass through routers R₁ and R2. Within the computer network 404 switching nodes that do not use routing tables, but may use a spanning tree are located between routing nodes R₁ and R2. The current spanning tree can be subject to change, such as during an interface failure. The stored mesh data allows the computer network monitor to better understand the aspects of a failure of an interface on one of the nodes in computer network 404 (e.g., distinguish primary versus non-primary failures).

In the example of FIG. 4, the path engine unit 406 can query routing nodes (e.g., query the MIBs of each routing node) for interconnection information. The computer network monitor 404 can query, or poll, the MIBs of routing and/or non-routing nodes to determine connection information. The computer network monitor 404, path engine unit 406, and topology unit 408 need not be included among the computer network 401 of switches S₁, S₂, S₃ and S₄. The computer network monitor 404, path engine unit 406, and topology unit 408 can be located elsewhere in single or multiple computers. For example, the topology unit 408 can be located in the same or different computer as the path engine unit 406 or the computer network monitor 404.

The foregoing methods can be implemented in a computer readable medium containing a computer program for performing the functions described herein.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

What is claimed is:

1. A method of determining a mesh in a computer network comprising:
obtaining topology information that indicates which nodes in the computer network are interconnected including producing, for a first node in the computer network, a list of identifiers of nodes connected to the first node; and
examining the topology information to determine the mesh in the computer network, the examining of the topology information including using the list to determine candidate nodes for inclusion in the mesh.

2. The method of claim 1, wherein the mesh is a maximal mesh.

3. The method of claim 2, wherein multiple maximal meshes are determined.

4. The method of claim 1, wherein the topology information is node information, and the node information is determined from interface information that indicates which interfaces in the computer network are interconnected.

5. The method of claim 1, wherein the candidate nodes are examined to determine whether they interconnect with each node in a fully-connected group of nodes.

6. The method of claim 1, wherein the examining of the topology information uses recursion.

7. A method of determining a mesh in a computer network comprising:
obtaining interface information that indicates which interfaces in the computer network are interconnected;
using the interface information to determine node information indicating which nodes of the computer network are interconnected; and
examining the node information to determine the mesh in the computer network.

8. The method of claim 7, wherein the mesh is a maximal mesh.

9. The method of claim 7, wherein multiple maximal meshes are determined.

10. The method of claim 7, wherein a list of identifiers of nodes connected to a first node is produced.

11. The method of claim 10, wherein the examining of the node information includes using the list to determine candidate nodes for inclusion in the mesh.

12. The method of claim 11, wherein the candidate nodes are examined to determine whether they interconnect with each node in a fully-connected group of nodes.

13. The method of claim 7 wherein the examining of the topology information uses recursion.

14. A computer readable medium containing a program which executes the following procedure to determine a mesh in a computer network:
obtaining topology information that indicates which nodes in the computer network are interconnected including producing, for a first node in the computer network, a list of identifiers of nodes connected to the first node; and
examining the topology information to determine the mesh in the computer network, the examining of the topology information including using the list to determine candidate nodes for inclusion in the mesh.

15. The method of claim 14, wherein multiple maximal meshes are determined.

16. The method of claim 14, wherein the topology information is node information, and the node information is determined from interface information that indicates which interfaces in the computer network are interconnected.

17. The method of claim 14, wherein the examining of the topology information uses recursion.

18. A computer readable medium comprising a program which executes the following procedure to determine a mesh in a computer network:
obtaining interface information that indicates which interfaces in the computer network are interconnected;
using the interface information to determine node information indicating which nodes of the computer network are interconnected; and
examining the node information to determine the mesh in the computer network.

19. The method of claim 18, wherein multiple maximal meshes are determined.

20. The method of claim 18, wherein a list of identifiers of nodes connected to a first node is produced.

21. The method of claim 20, wherein the examining of the node information includes using the list to determine candidate nodes for inclusion in the mesh.

22. The method of claim 18, wherein the examining of the topology information uses recursion.
